(19) United States
(12) Patent Application Publication
(10) Pub. No.: US 2026/0081486 A1
(43) Pub. Date: Mar. 19, 2026

(54) STATOR

(71) Applicant: Schaeffler Technologies AG & Co. KG, Herzogenaurach (DE)

(72) Inventors: Christian Silvery, Walzbachtal (DE); Alexandre Fischer, Strasbourg (FR)

(21) Appl. No.: 19/106,962

(22) PCT Filed: Aug. 2, 2023
(86) PCT No.: PCT/DE2023/100567

§ 371 Date: Feb. 26, 2025

(30) Foreign Application Priority Data
Aug. 30, 2022 (DE) 10 2022 121 880.5

(51) Int. Cl. H02K 1/20; H02K 3/50; H02K 9/19

(52) U.S. Cl. CPC H02K 1/20; H02K 3/50; H02K 9/19; H02K 2203/09

(57) ABSTRACT

A stator for an electric machine is disclosed. The state includes a stator body having a plurality of stator teeth arranged distributed circumferentially and stator grooves formed between the stator teeth and extending through the stator body in the axial direction, wherein electrical conductors of a stator winding are arranged in the stator grooves, the electrical conductors emerging from the end of the stator body at least so as to form an end winding and being able to be energized by means of an electrical contact-making element, wherein the stator body is formed from a plurality of layered stator sheets, and the stator body has a plurality of fluid channels through which a cooling fluid can flow and which extend through the stator body in the axial direction.

### CROSS-REFERENCE TO RELATED APPLICATION

The present application is the U.S. National Phase of PCT Patent Application Number PCT/DE2023/100567, filed on Aug. 2, 2023, which claims priority to German Patent Application Number 10 2022 121 880.5, filed Aug. 30, 2022, the entire disclosures of which are incorporated by reference herein.

### TECHNICAL FIELD

The present disclosure relates to a stator for an electric machine, comprising a stator body having a plurality of stator teeth arranged in a circumferentially distributed manner and stator grooves formed between the stator teeth and extending through the stator body in the axial direction, wherein electrical conductors of a stator winding are arranged in the stator grooves, the electrical contacting elements emerging from the end side of the stator body at least so as to form an end winding and being able to be energized by means of an electrical contacting element, wherein the contacting element comprises an electrically isolating base body, on and/or in which electrical contacting conductors run, the electrical contacting elements interconnecting the electrical conductors on the end winding and/or providing an electrical connection for the purpose of energization, wherein the stator body is formed from a plurality of layered stator sheets, and the stator body has a plurality of fluid channels through which a cooling fluid can flow and which extend through the stator body in the axial direction, wherein a plurality of the fluid channels emerge from an end side of the stator body so as to form a respective opening.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to.

A detailed description of an electric drive can be found in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor that is arranged to be concentric and coaxial with a bevel gear differential, wherein a shiftable 2-speed planetary gear set is arranged in the power train between the electric motor and the bevel gear differential and is also positioned to be coaxial with the electric motor or the bevel gear differential or spur gear differential. The drive unit is very compact and allows for a good compromise between gradability, acceleration and energy consumption due to the shiftable 2-speed planetary gear set. Such drive units are also referred to as e-axles or electrically operable drive trains.

In addition to purely electrically operated drive trains, hybrid drive trains are also known. Such drive trains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, drive can also be provided by the internal combustion engine and the electric motor at the same time in certain operating situations.

In the development of electric machines intended for e-axles or hybrid modules, there is a continuing need to increase their power densities, so the cooling of electric machines required for this is growing in importance. Owing to the necessary cooling capacities, hydraulic fluids such as cooling oils have become established in most concepts for the removal of heat from the thermally loaded regions of an electric machine.

Jacket cooling as well as end winding cooling are known, for example, from the prior art for cooling electric machines by means of hydraulic fluids. While jacket cooling transfers the heat generated at the outer surface of the stator laminated core into a cooling circuit, the heat transfer takes place in the case of the end winding cooling immediately at the conductors outside the stator laminated core in the region of the winding heads into the fluid.

Further improvements are provided by separate cooling channels, which are introduced both in the stator laminated core (see, for example, EP3157138 A1) and in the slot, in addition to the conductors (see, for example, Markus Schiefer: Indirekte Wicklungskühlung von hochausgenutzten permanenterregten Synchronmaschinen mit Zahnspulenwicklung [Indirect Winding Cooling of Highly Utilized Permanently Excited Synchronous Machines with Toothed Coil Winding], dissertation, Karlsruhe Institute of Technology (KIT), 2017).

Increasingly, electric machines without a housing are also being used, for example in order to save weight. In the case of such high output class electric machines without a housing, it is usually necessary to actively cool the laminated cores. For this purpose, cooling channel paths are usually necessary that require a series and/or parallel connection of the cooling channels in the laminated core. To realize this, components are placed at the inlets and/or outlets of the cooling channels that control the diversion of the cooling fluid into the corresponding cooling channels. In this regard, it is also possible that multiple components are required for these diverting purposes. What these components have in common is that additional contours must be provided for the diversion of the cooling fluid in each case. These contours are sometimes complex and therefore generally expensive to produce. Furthermore, such components for diverting the cooling fluid in the laminated cores can lead to a high pressure loss in the cooling circuit, which is generally undesirable.

### SUMMARY

The object of the disclosure is therefore to provide a stator which has optimized cooling.

This object is achieved by a stator for an electric machine, comprising a stator body having a plurality of stator teeth arranged in a circumferentially distributed manner and stator grooves formed between the stator teeth and extending through the stator body in the axial direction, wherein electrical conductors of a stator winding are arranged in the stator grooves, the electrical contacting elements emerging from the end side of the stator body at least so as to form an end winding and being able to be energized by means of an electrical contacting element, wherein the contacting element comprises an electrically isolating base body, on and/or in which electrical contacting conductors run, the electrical contacting elements interconnecting the electrical conductors on the end winding and/or providing an electrical connection for the purpose of energization, wherein the stator body is formed from a plurality of layered stator sheets, and the stator body has a plurality of fluid channels through which a cooling fluid can flow and which extend through the stator body in the axial direction, wherein a plurality of the fluid channels emerge from an end side of the stator body so as to form a respective opening. wherein the base body has at least one opening fluidically connected to at least one of the openings of the stator body, so that, during operation of the stator, cooling fluid enters the base body of the contacting element from the stator body.

This provides the advantage that improved cooling of the electrical contacting element and its electrical conductor can be provided by connection to the cooling circuit of the stator body. The resulting improved cooling performance can contribute to optimized efficiency and lower thermal losses during operation of the stator.

The stator according to the disclosure also has the advantage that the number of components to be assembled during construction of the stator can be reduced, which can contribute to a reduction in weight and component complexity. This is facilitated in particular by the integration of the fluid guide into the contacting element.

The individual elements of the claimed subject matter of the disclosure are explained first in the order in which they are mentioned in the claims, after which particularly preferred embodiments of the subject matter of the disclosure are described.

The stator according to the disclosure is intended for use in an electrical machine. The electric machine is used to convert electrical energy into mechanical energy and/or vice versa, and generally comprises a stationary part referred to as a stator or armature, and a part referred to as a rotor, which is arranged movably, in particular rotatably, relative to the stationary part. In particular, the electric machine is dimensioned such that vehicle speeds of more than 50 km/h, preferably more than 80 km/h, and in particular more than 100 km/h can be achieved. The electric motor particularly preferably has an output of more than 30 kW, preferably more than 50 kW, and in particular more than 70 kW. Furthermore, it is preferred that the electric machine provides speeds greater than 5000 rpm, particularly preferably greater than 10,000 rpm, very particularly preferably greater than 12,500 rpm.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

Electrical conductors of a stator winding are embedded in the stator grooves of the stator according to the disclosure. A stator winding comprises at least one electrically conductive conductor which has a longitudinal extension that is much greater than its diameter. The conductor can generally have any cross-sectional shape. Rectangular cross-sectional shapes are preferred since these allow high packing densities and consequently high power densities to be achieved. Particularly preferably, a conductor is formed of copper. Preferably, a conductor is insulated. To insulate the conductor or stator winding, for example, mica paper, which for mechanical reasons can be reinforced by a glass fabric bearer, may be wound in tape form around one or more stator windings, which are impregnated by means of a curing resin. In principle, it is also possible to use a curable lacquer layer without mica paper to insulate a conductor or stator winding.

The stator according to the disclosure also has a stator body. The stator body can be made in one piece or in multiple pieces, in particular in a segmented manner. A one-piece stator body is characterized by the fact that the entire stator body is formed in one piece as viewed over the circumference. The stator body is usually formed from a plurality of stacked laminated electrical steel sheets, wherein each of the electrical steel sheets is closed to form a circular ring. A segmented stator body is characterized by the fact that it is constructed from individual stator segment parts. The stator body can be constructed from individual stator teeth or stator tooth groups, wherein each individual stator tooth or each individual stator tooth group can be formed from a plurality of stacked laminated electrical steel sheets, wherein each of the electrical sheets is designed as a stator segment lamination part.

The stator body is preferably formed from one or more stator laminated cores. A stator laminated core is understood to mean a plurality of laminated individual sheets or stator sheets, which are generally made from electrical steel sheets and are layered and packed one on top of the other to form a stack or what is referred to as a stator laminated core. The individual sheets can then remain held together in the laminated core by adhesive bonding, welding or screwing.

The stator teeth of the stator are preferably formed in the stator body. Stator teeth are components of the stator body which are designed as circumferentially spaced, tooth-like parts of the stator body that are directed radially inward, with an air gap for the magnetic field being formed between the free ends of the stator teeth and a rotor body. The gap between the rotor and the stator is referred to as the air gap. In a radial flux machine, this is a substantially annular gap with a radial width that corresponds to the distance between the rotor body and the stator body.

According to an advantageous embodiment of the disclosure, the plurality, preferably all, of the electrical conductors have a substantially rectangular contour in cross section. The advantage of this design is that electrical conductors that are generally available as standard can be used to form the stator winding, which is particularly favorable in terms of the manufacturing costs of the stator.

The function of the cooling fluid in the stator according to the disclosure is to dissipate heat as efficiently as possible from regions of the stator that are heating up and to prevent these regions from overheating. In addition to this main task, the cooling fluid can in particular also provide lubrication and corrosion protection for the moving parts and/or the metal surfaces of the cooling system of the stator or the electric machine. In addition, it can, in particular, also remove contaminants (for example as caused by abrasion), water and air. The cooling fluid is preferably a liquid. The cooling fluid can in particular be an oil. In principle, however, it is also conceivable to use aqueous cooling fluids, for example also emulsions, such as water-glycol mixtures.

The fluid channels of the stator can be connected to a hydraulic cooling system with a hydraulic cooling circuit. Such a cooling system is used to dissipate the heat generated by electrical losses within an electric machine. Such a cooling system can have, among other things, cooling channels within the rotor (rotor cooling channel) and/or stator (stator cooling channel), through which a corresponding cooling fluid is guided for the purpose of dissipating the heat.

The cooling fluid can particularly preferably be pumped through the hydraulic circuit by means of a pump. In principle, it is conceivable to design a plurality of hydraulic circuits in order to cool the electrical machine or the stator. In this case, it is highly preferred that the fluid channels of the stator are connected to a hydraulic cooling circuit or to various cooling circuits of the cooling system. In particular, by connecting to several cooling circuits, it is possible to provide more precise cooling, since, for example, the temperature of the cooling fluid when entering the cooling channels of the stator, the flow velocity of the cooling fluid or even the type of cooling fluid (oil, emulsion) can be adjusted.

According to an advantageous embodiment of the disclosure, the fluid channels can extend axially parallel to the axis of rotation of a rotor rotatably mounted relative to the stator, which has proven to be advantageous in terms of cooling capacity and pressure loss.

According to an advantageous embodiment of the disclosure, it can be provided that the at least one opening of the base body bears against one of the openings of the stator body, preferably with the interposition of a sealing element.

The advantage of this design is that a particularly cost-effective fluidic connection can be formed between the stator body and the base body.

According to a further preferred development of the disclosure, it can also be provided that the at least one opening of the base body of the contacting element fluidically connects two openings of the stator body to one another, so that, during operation of the stator, cooling fluid emerges from a first opening of the stator body in order to subsequently enter a second opening via the opening of the base body. It can thereby be achieved that the cooling fluid can be guided through the fluid channels of the stator body according to a hydraulic path formed in the base body. In principle, any manner of fluidic interconnections and fluid guides are conceivable, wherein a meandering shape has proven to be particularly advantageous with regard to the cooling effect and pressure loss.

Furthermore, according to an equally advantageous embodiment of the disclosure, it can be provided that the at least one opening of the base body of the contacting element fluidically connects two circumferentially adjacent openings of the stator body. The advantageous effect of this design is based on the fact that it can further reduce pressure loss in the fluidic cooling circuit of the stator.

According to a further particularly preferred embodiment of the disclosure, it can be provided that the at least one opening of the base body of the contacting element is designed as a pocket, which also has an advantageous effect regarding pressure loss in the fluidic cooling circuit of the stator.

Furthermore, the disclosure can also be further developed in such a way that the at least one opening is connected to a cooling channel running through the base body of the contacting element. The advantage of this design is that the cooling effect within the contacting element can be further optimized, for example by guiding a cooling channel to areas of particularly high thermal stress in the contacting element. For this purpose, a cooling channel can have a corresponding shape and a corresponding course through the contacting element. In principle, it is of course also possible for the contacting element to have a plurality of cooling channels. The cooling channels can also be fluidically connected to one or more of the openings of the base body of the contacting element.

In a likewise preferred embodiment variant of the disclosure, it can therefore also be provided that the base body of the contacting element has a plurality of openings, wherein each of the openings of the base body is fluidically connected to at least one opening of the stator body assigned to it, whereby the cooling effect within the contacting element can be further improved.

It may also be advantageous to further develop the disclosure in such a way that the plurality of openings of the base body is fluidically connected to the openings of the stator body in such a way that a meandering fluid path is defined for the cooling fluid, which has proven to be particularly advantageous with regard to pressure loss and the cooling effect.

According to a further preferred embodiment of the subject matter of the disclosure, it can be provided that the cooling fluid is a liquid, in particular an oil. In principle, however, it is also conceivable to use aqueous cooling fluids, for example also emulsions. It would also be conceivable that the cooling fluid is in the form of a gas.

Finally, the disclosure can also be advantageously designed such that the base body of the contacting element is formed from a plastic, which is preferable for production engineering reasons and with regard to a weight-optimized design.

The disclosure is explained in more detail below with reference to figures without limiting the general concept of the disclosure.

### BRIEF DESCRIPTION OF THE DRAWINGS

In the drawings:

FIG. 1 shows a stator in a cross-sectional view,

FIG. 2 shows a stator in an exploded view,

FIG. 3 shows a stator with an electrical contacting element in a perspective view,

FIG. 4 shows a stator with an electrical contacting element and exposed end winding in a perspective view,

FIG. 5 shows a first embodiment of a contacting element in a perspective view,

FIG. 6 shows a second embodiment of a contacting element in three different views,

FIG. 7 shows a transparent representation of the second embodiment of the contacting element

FIG. 8 shows a third embodiment of a contacting element in a perspective view and a transparent representation,

FIG. 9 shows a stator body with exposed fluid channels and the third embodiment of a contacting element in a side view,

FIG. 10 shows a stator body with exposed fluid channels and the third embodiment of a contacting element in a detailed view.

### DETAILED DESCRIPTION

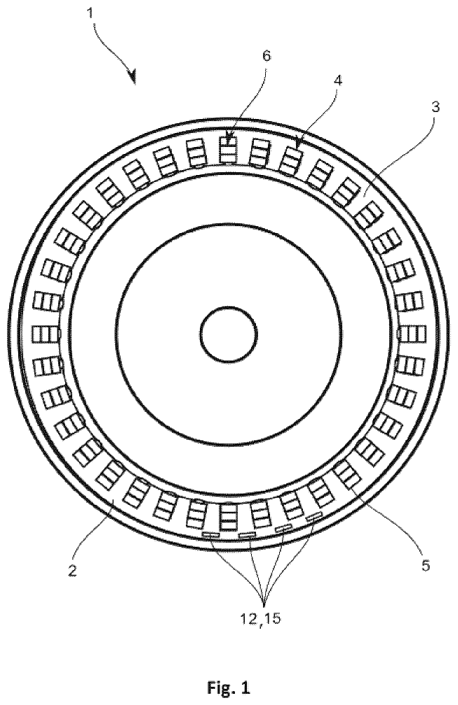

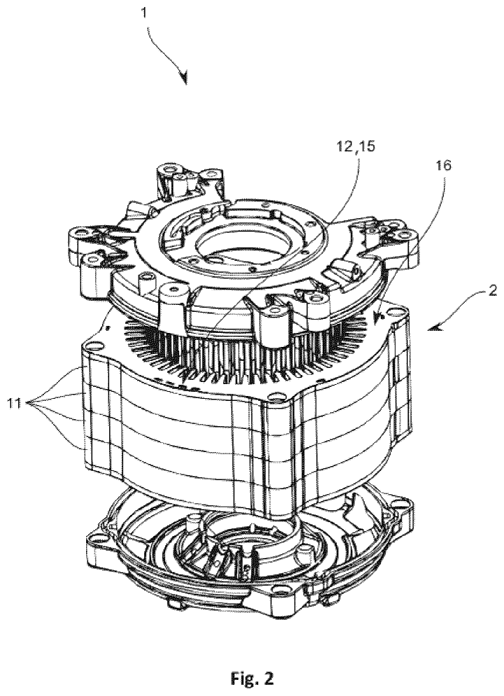

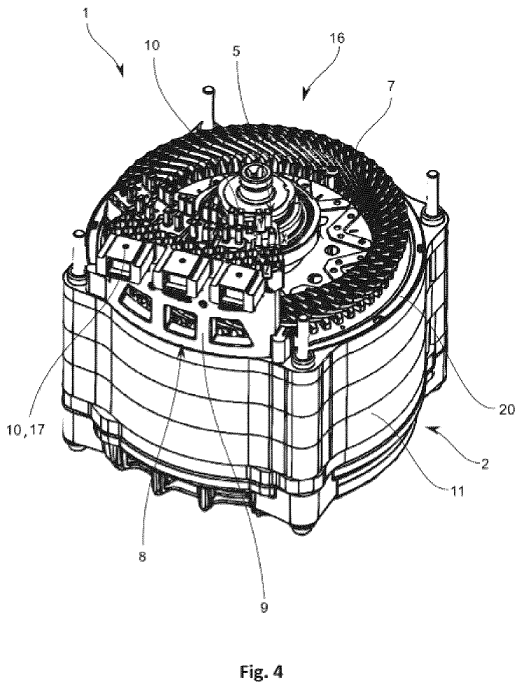

FIG. 1 shows a stator 1 for an electric machine, comprising a stator body 2 with a plurality of stator teeth 3 arranged in a circumferentially distributed manner and stator grooves 4 formed between the stator teeth 3 and extending in the axial direction through the stator body 2. Electrical conductors 5 of a stator winding 6 are arranged in the stator grooves 4, which emerge from the end side of the stator body 2 at least so as to form an end winding 7 and are able to be energized via an electrical contacting element 8, which can be clearly seen by looking at FIG. 1 together with FIG. 4. FIG. 2 shows the stator 1 known from FIG. 1 in an exploded view with end-side end shields, which are not specified in further detail.

Despite the fact that only four openings 15 of the fluid channels 12 are shown in a circular arc section in FIGS. 1-2, it is understood that a plurality of openings 15 and fluid channels 12 can also extend in a circular ring-like manner over the entire circumference of the stator body 2.

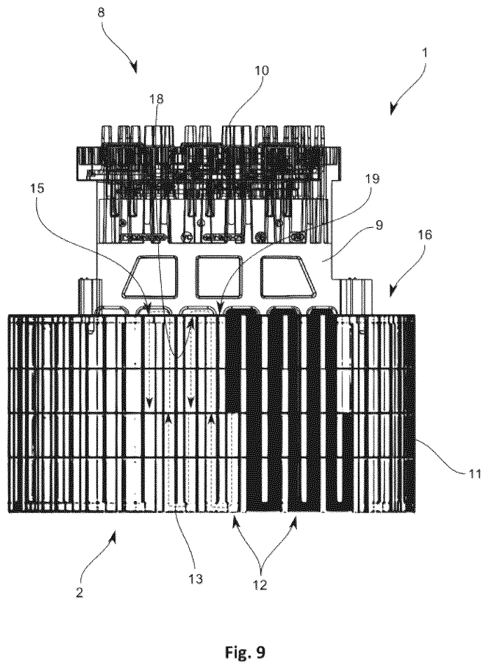

The stator body 2 is formed from a plurality of layered stator sheets 11 and has a plurality of fluid channels 12 through which a cooling fluid 13 can flow and which extend through the stator body 2 in the axial direction, wherein a plurality of the fluid channels 12 emerge from an end side 16 of the stator body 2, so as to form a respective opening 15. This can be clearly seen again by looking at FIG. 1 together with FIG. 9.

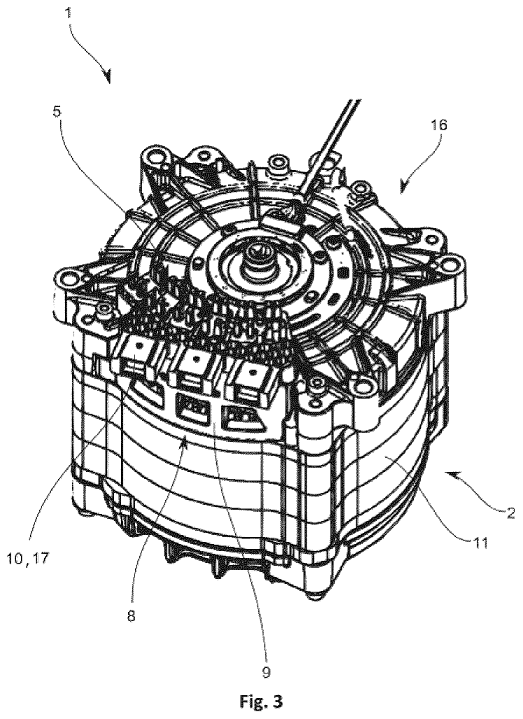

A contacting element 8, as shown in the installed state on the stator 1 in FIGS. 3-4, has an electrically isolating base body 9, on and/or in which electrical contacting conductors 10 run, the electrical contacting conductors interconnecting the electrical conductors 5 on the end winding 7 and/or providing an electrical connection 17 for the purpose of energization.

The base body 9 has at least one opening 18 fluidically connected to at least one of the openings 15 of the stator body 2, so that, during operation of the stator 1, cooling fluid 13 enters the base body 9 of the contacting element 8 from the stator body 2, as can be seen, for example, from FIG. 9. The base body 9 of the contacting element 8 is formed from a plastic.

FIG. 4 shows an embodiment of the stator 1 in an electrical machine with a stator winding 6 designed as a wave coil and a contacting element 8 designed as a high-voltage connection. Here, the cooling fluid 13 is distributed and directed within the stator body 2. This guidance of the cooling fluid 13 through the stator body 2 is carried out together with the contacting element 8 designed as a high-voltage connection, which will be explained in more detail below.

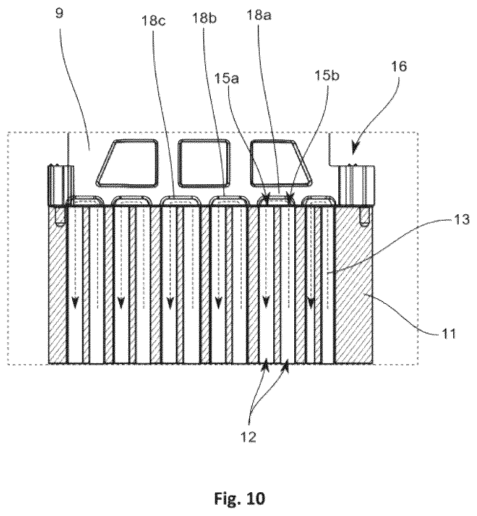

To guide and redirect the cooling fluid 13 in the stator body 2, the contacting element 8 has a specially shaped base body 9 made of plastic. This plastic housing of the high-voltage terminal contains several electrical contacting conductors 10 designed as copper rails that run through the base body 9. Furthermore, the base body 9 having the openings 18 has a geometry for deflecting the cooling fluid 13. It can be clearly seen, in particular from FIGS. 9-10, how this base body 9, which is designed as a plastic housing, enables a deflection of the cooling fluid 13. The base body 9 is placed on the end side of the stator body 2 in a sealing manner opposite the openings 15 of the stator body 2 and is subjected to a contact pressure required for sealing.

On the stator body 1, away from the contacting element 8, a distribution or deflection of the cooling fluid 13 is realized by a sealing ring 20 made of aluminum, which can be seen in FIG. 4, so that, in these sections of the stator body 2, a meandering guidance of the cooling fluid 13 through the stator body 2 is formed. The necessary guidance of the cooling fluid 13 through the stator body 2 for continuing the meandering guidance of the cooling fluid 13 through the stator body in the region of the contacting element 8 is provided by openings 18 in the base body 9 of the contacting element 8. In addition to the improved cooling of the contacting element 8, these openings 18 offer the advantage that the mass of the contacting element 8 and the stator 1 can be reduced. The sealing ring 20 is interrupted in the region of the contacting element 8 and thus has a circular ring segment-like shape. The sealing ring 20 therefore does not extend between the contacting element 8 and the stator body 2. The redirection and guidance of the cooling fluid 13 takes place directly in the contacting element 8 designed as an HV terminal. The advantage of this design is, among other things, that the weight of the stator 1 can be reduced by substituting a metallic component with a plastic component.

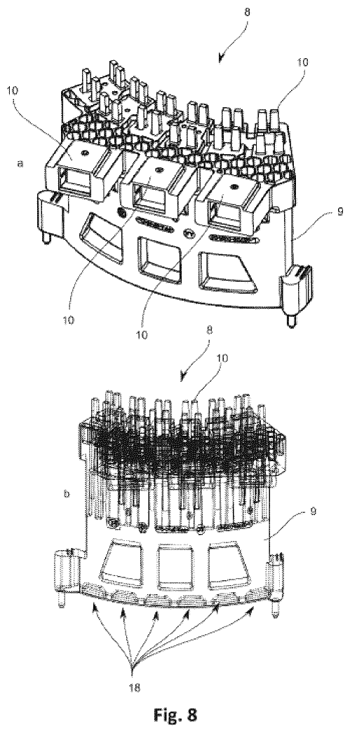

FIG. 8 shows an embodiment of the contacting element 8 as an HV terminal with three contacting conductors 10 designed as busbar connections to the power electronics. These are encapsulated in a plastic to form the base body 9 in order to ensure the necessary air and creepage distances. A neutral star busbar then enables the entire electrical interconnection of the electrical machine. The contacting element 8 known from FIG. 8 has a circular ring segment-like spatial shape and, at the front end facing the stator body 2, a plurality of openings 18 formed as pockets, by means of which the cooling fluid 13 can be guided in a meandering manner through the stator body 2, as already described above.

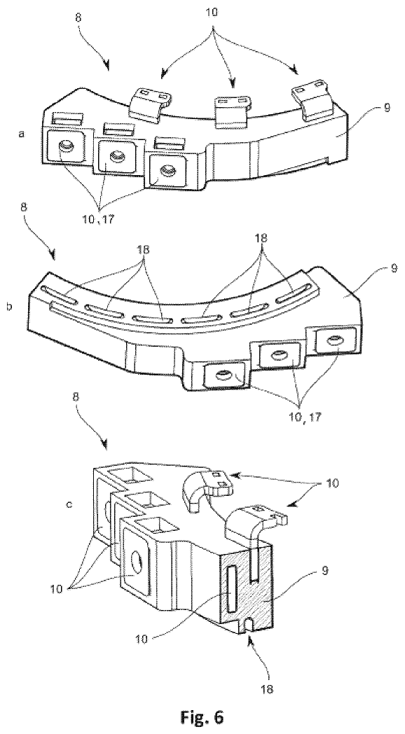

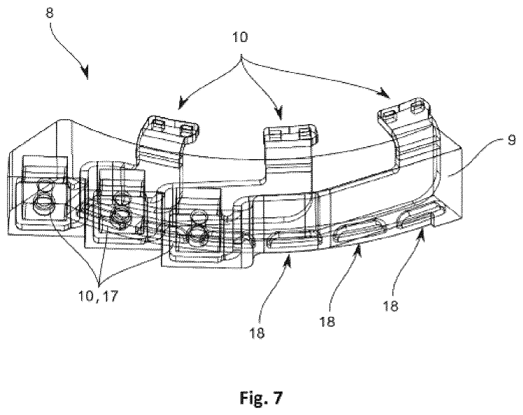

FIGS. 6-7 show another possible embodiment of the contacting element 8 as an HV connection. Three contacting conductors 10 designed as busbars are integrated inside the base body 9 of the HV connection and, together with the pressed-in nuts, form a connection 17 for connecting power electronics. The contacting element 8 designed as an HV connection also has openings 18 designed as pockets on the end side facing the stator body 2, which then direct the cooling fluid 13 in a meandering path through the stator body 2.

For this purpose, the openings 18 of the base body 9 bear against the openings 15 of the stator body 2 with a sealing element 19 arranged therebetween. It can be clearly seen from FIG. 9 that a respective opening 18 of the base body 9 of the contacting element 8 fluidically connects two openings 15a, 15b of the stator body 2 to one another, so that, during operation of the stator 1, cooling fluid 13 emerges from a first opening 15a of the stator body 2 in order to subsequently enter a second opening 15b via the opening 18 of the base body 9. This is shown as an example in FIG. 10. In this case, an opening 18 of the base body 9 of the contacting element 8 fluidically connects two circumferentially adjacent openings 15a, 15b of the stator body 2. The openings 18 of the base body 9 of the contacting element 8 are designed as a pocket.

In FIG. 9, the contacting element 8 configured as an HV terminal sits directly on a sealing element 19 and thus presses the sealing element 19 against the end side of the stator body 2.

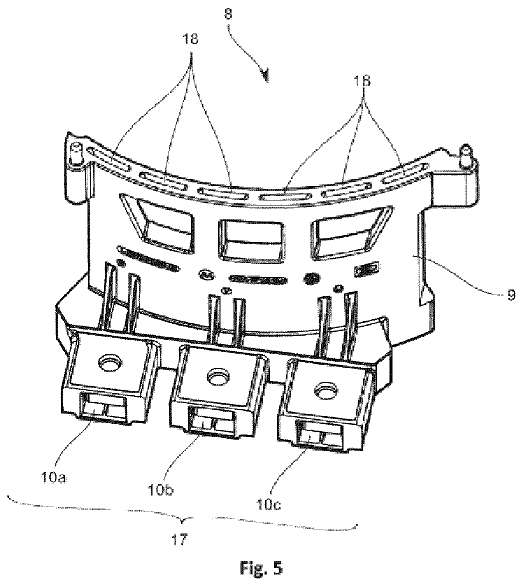

Also visible from FIGS. 5-10 is that the base body 9 of the contacting element 8 has a plurality of openings 18a, 18b, 18c, wherein each of the openings 18a, 18b, 18c of the base body 9 is fluidically connected to at least one opening 15 of the stator body 2 assigned to it. As shown in FIGS. 9-10, the openings 18a, 18b, 18c of the base body 9 are fluidically connected to the openings 15 of the stator body 2 in such a way that a meandering fluid path is defined for the cooling fluid 13.

In principle, it would also be conceivable that one or more of the openings 18 are connected to a cooling channel running through the base body 9 of the contacting element 8, which, however, is not shown in the figures.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SYMBOLS

1 Stator
2 Stator body
3 Stator teeth
4 Stator grooves
5 Conductor
6 Stator winding
7 End winding
8 Contacting element
9 Base body
10 Contacting conductor
11 Stator sheets
12 Fluid channels
13 Cooling fluid
15 Opening
16 End side
17 Connection
18 Opening
19 Sealing element
20 Sealing ring

1. A stator for an electric machine comprising
a stator body having a plurality of stator teeth arranged in a circumferentially distributed manner and stator grooves formed between the stator teeth and extending in the axial direction through the stator body, wherein electrical conductors of a stator winding are arranged in the stator grooves, the electrical conductors emerging from the end side of the stator body at least so as to form an end winding and being able to be energized by means of an electrical contacting element,
wherein the contacting element comprises an electrically isolating base body, on and/or in which electrical contacting conductors run, the electrical contacting conductors interconnecting the electrical conductors on the end winding and/or providing an electrical connection for the purpose of energization,
wherein the stator body is formed from a plurality of layered stator sheets, and the stator body has a plurality of fluid channels through which a cooling fluid can flow and which extend through the stator body in the axial direction, wherein a plurality of the fluid channels emerge from an end side of the stator body so as to form a respective opening,
wherein the base body includes at least one opening fluidically connected to at least one of the openings of the stator body, so that, during operation of the stator, cooling fluid enters the base body of the contacting element from the stator body.

2. The stator according to claim 1, wherein the at least one opening of the base body bears against one of the openings of the stator body, interposed by a sealing element.

3. The stator according to claim 1, wherein the at least one opening of the base body of the contacting element fluidically connects two openings of the stator body to one another, so that, during operation of the stator, cooling fluid emerges from a first opening of the stator body in order to subsequently enter a second opening via the opening of the base body.

4. The stator according to claim 1, wherein the at least one opening of the base body of the contacting element fluidically connects two circumferentially adjacent openings of the stator body.

5. The stator according to claim 1, wherein the at least one opening of the base body of the contacting element is designed as a pocket.

6. The stator according to claim 1, wherein the at least one opening is connected to a cooling channel running through the base body of the contacting element.

7. The stator according to claim 1, wherein the base body of the contacting element has a plurality of openings, wherein each of the openings of the base body is fluidically connected to at least one opening of the stator body.

8. The stator according to claim 7, wherein the plurality of openings of the base body is fluidically connected to the openings of the stator body in to form a meandering fluid path for the cooling fluid.

9. The stator according to claim 1, wherein the cooling fluid is a liquid, in particular an oil.

10. The stator according to claim 1, wherein the base body of the contacting element is formed from a plastic.

11. A stator for an electric machine comprising
a stator body comprising a plurality of stator teeth arranged in a circumferentially distributed manner and stator grooves formed between the stator teeth and extending in the axial direction through the stator body, wherein electrical conductors of a stator winding are arranged in the stator grooves, the electrical conductors emerging from the end side of the stator body to form an end winding and for energizing by an electrical contacting element,
wherein the contacting element comprises an electrically isolating base body including electrical contacting conductors, the electrical contacting conductors interconnecting the electrical conductors on the end winding,
wherein the stator body is formed from a plurality of layered stator sheets and includes a plurality of fluid channels through which a cooling fluid flows and extend through the stator body in the axial direction, wherein a plurality of the fluid channels emerge from an end side of the stator body to form a respective opening,
wherein the base body includes at least one opening fluidically connected to at least one of the openings of the stator body to cause, during operation of the stator, cooling fluid to enter the base body of the contacting element from the stator body,
wherein the at least one opening of the base body of the contacting element fluidically connects two openings of the stator body to one another to cause, during operation of the stator, cooling fluid to emerge from a first opening of the stator body in order to subsequently enter a second opening via the opening of the base body.

12. The stator according to claim 11, wherein the at least one opening of the base body bears against one of the openings of the stator body, interposed by a sealing element.

13. The stator according to claim 11, wherein the at least one opening of the base body of the contacting element fluidically connects two circumferentially adjacent openings of the stator body.

14. The stator according to claim 11, wherein the at least one opening of the base body of the contacting element is designed as a pocket.

15. The stator according to claim 11, wherein the at least one opening is connected to a cooling channel running through the base body of the contacting element.

16. The stator according to claim 11, wherein the base body of the contacting element has a plurality of openings, wherein each of the openings of the base body is fluidically connected to at least one opening of the stator body.

17. The stator according to claim 16, wherein the plurality of openings of the base body is fluidically connected to the openings of the stator body in to form a meandering fluid path for the cooling fluid.

18. The stator according to claim 1, wherein the cooling fluid comprises a liquid.

19. The stator according to claim 1, wherein the base body of the contacting element is formed from a plastic.

20. An electric machine comprising
a rotor; and
a stator, the stator comprising:
a stator body comprising a plurality of stator teeth arranged in a circumferentially distributed manner and stator grooves formed between the stator teeth and extending in the axial direction through the stator body, wherein electrical conductors of a stator winding are arranged in the stator grooves, the electrical conductors emerging from the end side of the stator body to form an end winding and for energizing by an electrical contacting element,
wherein the contacting element comprises an electrically isolating base body including electrical contacting conductors, the electrical contacting conductors interconnecting the electrical conductors on the end winding,
wherein the stator body is formed from a plurality of layered stator sheets and includes a plurality of fluid channels through which a cooling fluid flows and extend through the stator body in the axial direction, wherein a plurality of the fluid channels emerge from an end side of the stator body to form a respective opening,
wherein the base body includes at least one opening fluidically connected to at least one of the openings of the stator body to cause, during operation of the stator, cooling fluid to enter the base body of the contacting element from the stator body.
